(19) United States
(12) Patent Application Publication
(10) Pub. No.: US 2007/0123244 A1
(43) Pub. Date: May 31, 2007

(54) Declaring Terminal Provisioning with Service Guide

(75) Inventor: Toni Paila, Rye, NY (US)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/548,025

(22) Filed: Oct. 10, 2006

Related U.S. Application Data
(60) Provisional application No. 60/726,172, filed on Oct. 14, 2005.

(51) Int. Cl. H04M 3/00

(52) U.S. Cl. 455/419

(57) ABSTRACT

Provided are apparatuses and methods in a digital broadcast transmission system for transmitting terminal provisioning as a service or as an access of a service. Terminal provisioning may provide a terminal with, for example, configuration parameters, data, or applications to a terminal or group of terminals. Transmission of terminal provisioning may be accomplished in an ESG fragment which may include, for example, a service fragment, an access fragment or a content fragment. In one example, a parameter may be included in the service fragment of an ESG fragment that may identify a type of service fragment. The type of service fragment may be indicated as terminal provisioning services. In another example, a parameter may be included in an access fragment of an ESG fragment for indicating terminal provisioning as a service or access of a service. Also, a content fragment may include terminal provisioning messages as files.

### CROSS REFERENCE TO RELATED APPLICATIONS

This application claims the benefit of U.S. Provisional Application No. 60/726,172, which was filed Oct. 14, 2005, and which is incorporated herein by reference.

### FIELD

Embodiments of the invention relate generally to communications networks. More specifically, embodiments of the invention provide for providing terminal provisioning in a communication network.

### BACKGROUND

Generally, an Electronic Service Guide (ESG) enables a terminal to communicate what services are available to end users and how the services may be accessed. ESG fragments are independently existing pieces of the ESG. Traditionally, ESG fragments comprise XML documents, but more recently they have encompassed a vast array of items, such as for example, a SDP (Session Description Protocol) description, textual file, or an image. The ESG fragments describe one or several aspects of currently available (or future) service or broadcast programs. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, be addressed to a group of users, commonly known as multicasting. In the case in which the data is addressed to all users it is called broadcasting. The ESG data may be transmitted using different types of wireless digital networks including digital broadband broadcast, bidirectional, and/or multicast networks.

Terminal provisioning can provide for management of parameters in a broadcast or multicast system and distribution of the parameters or objects to terminals over the network. There is presently no effective system or method for effectively carrying out terminal provisioning in a communication system.

Thus, there exists a need for a method and system for terminal provisioning in a communication system.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example of the invention, a method for providing terminal provisioning to a terminal is provided. The method may include providing parameters corresponding to a file associated with terminal provisioning.

In another example of the invention, a method for providing terminal provisioning as a service to a terminal is provided in which a parameter corresponding to terminal provisioning is included in a service fragment of an ESG fragment. For example, the parameter may be an attribute indicating a type of service corresponding to terminal provisioning services.

In another example, a method for providing terminal provisioning as an access to a service is provided in which a parameter corresponding to terminal provisioning is included in an access fragment of an ESG fragment. For example, the parameter may indicate an application type that can consume the service.

In another example, a transmitter is provided for creating an ESG fragment containing terminal provisioning services or terminal provisioning as an access of a service.

In another example, a receiver is provided for receiving and parsing an ESG fragment to determine terminal provisioning as a service or terminal provisioning as an access of a service.

In another example, a computer program product comprising a computer-readable medium having computer-executable instructions embodied thereon is provided for receiving an ESG fragment and identifying terminal provisioning as a service or terminal provisioning as an access of a service.

### BRIEF DESCRIPTION OF THE DRAWINGS

A more complete understanding of the invention and the advantages thereof may be acquired by referring to the following description in consideration of the accompanying drawings, in which like reference numbers indicate like features, and wherein:

FIG. 1 illustrates a block diagram of a wireless communication system in which various aspects of the present invention may be implemented.

FIG. 2 illustrates a suitable digital broadcast receiver in which one or more illustrative embodiments of the invention may be implemented.

FIG. 3 illustrates a schematic diagram of an example of a transport object in which one or more illustrative embodiments of the invention may be implemented.

FIG. 4 illustrates examples of transporting single transport objects in which one or more illustrative embodiments of the invention may be implemented.

FIG. 5 illustrates an example of a receiver in which one or more illustrative embodiments of the invention may be implemented.

FIG. 6 illustrates an example of a transmitter in which one or more illustrative embodiments of the invention may be implemented.

FIG. 7 illustrates a flow chart of an example of transmitting an ESG fragment corresponding to terminal provisioning as a service or access of a service in which one or more illustrative embodiments of the invention may be implemented.

FIG. 8 illustrates a flow chart of an example of receiving an ESG fragment corresponding to terminal provisioning as a service or access of a service in which one or more illustrative embodiments of the invention may be implemented

### DETAILED DESCRIPTION

In the following description of the various embodiments, reference is made to the accompanying drawings, which form a part hereof, and in which is shown by way of illustration various embodiments of the invention. It is to be understood that other embodiments may be utilized and structural and functional modifications may be made without departing from the scope and spirit of the invention.

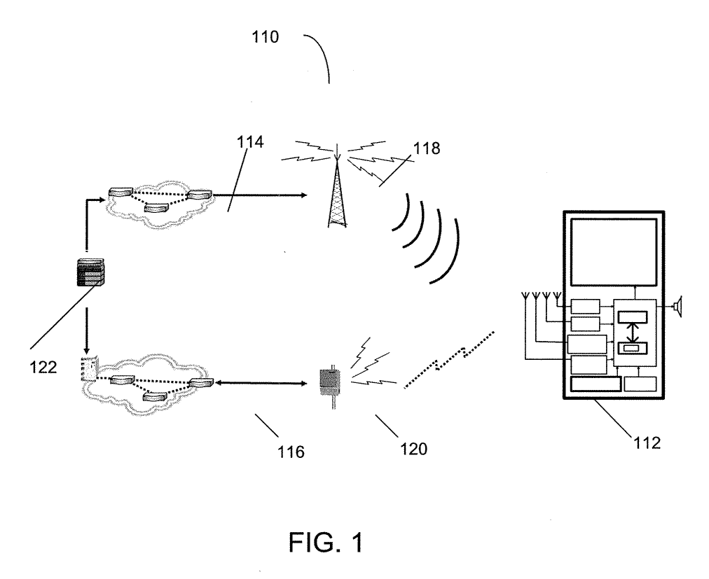

Aspects of the invention may be utilized across a broad array of networks and communication protocols. FIG. 1 illustrates an example of a wireless communication system 110 in which systems and methods in accordance with the invention may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadband broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, AM/FM radio service providers, SMS/MMS push service providers, Internet content or access providers.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One type of DVB is Digital video broadcasting-handheld (DVB-H), a recently developed technology that increases the capabilities and services available on small handheld devices, such as mobile telephones. The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, may be incorporated into the TS. This enables a receiver device to correctly process the data contained within the TS.

Aspects of the present invention, however, are also applicable to other traditional digital mobile broadcast systems such as, for example, T-DAB, T/S-DMB, ISDB-T, ATSC, MediaFLO, and non-traditional systems such as 3GPP MBMS and 3GPP2BCMCS.

The broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116 or utilizing both networks.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), a Universal Mobile Telecommunications System (UMTS) or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection (for example, in an interactive transmission), applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

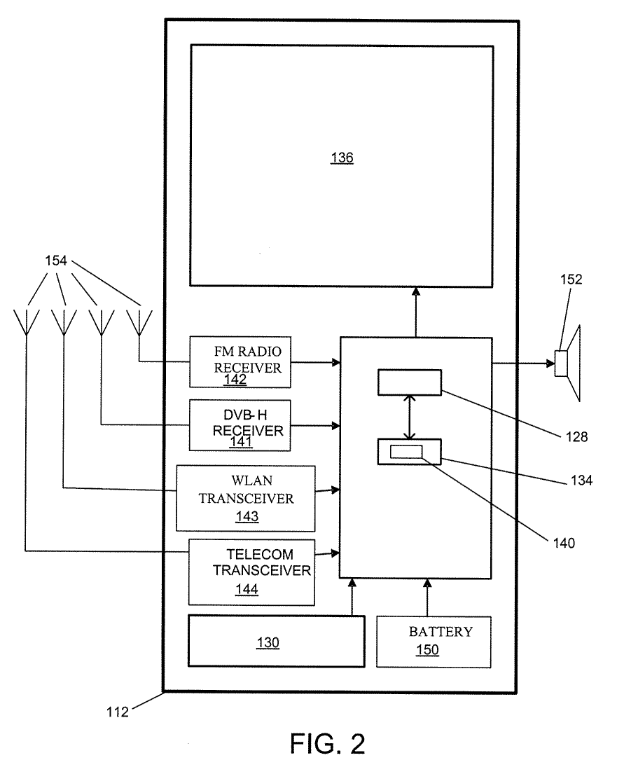

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, four arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H, DVB-T or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200 50-kbit/s audio program channels or 50 200-kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation. The power of receiver between bursts may be turned off to reduce power consumption.

In one example of the invention, ESG fragments may be delivered to a subscriber terminal in one or more data streams or channels. In this example, a plurality of channels (such as IP-packet streams) can be used to deliver ESG information to the subscriber terminal. For example, the ESG fragment may provide the subscriber terminal with notification of upcoming events to be provided by a service provider, changes in current events provided by a service provider or updated or on-going information for a user or group of users.

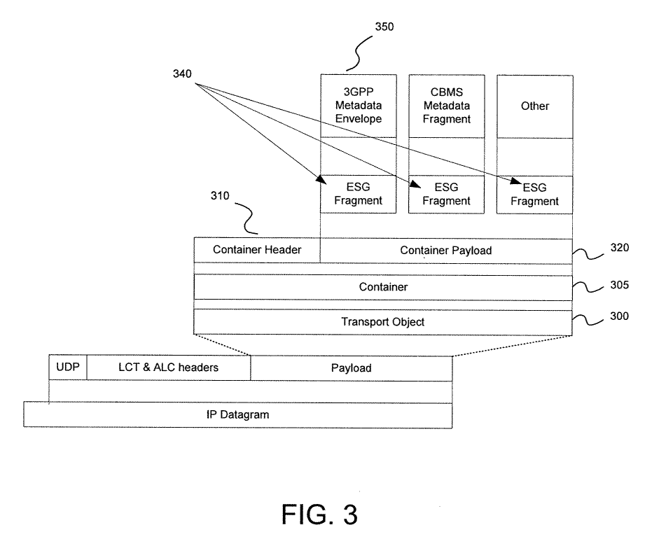

ESG fragments may be delivered in a transport object which may transport ESG information in a container. Thus, ESG fragments may be placed in a container that may be delivered in its own transport object. The container may further include a container header and a container payload, for example, in which the container header may provide information on where each container is located within the transport object. In one example, the transport object may contain a single container or a plurality of containers, each container including at least one ESG fragment. FIG. 3 is a diagram of an example transport object in accordance with at least one aspect of the present invention. As illustrated in the example of FIG. 3, a transport object 300 may comprise a container that may include a container header 310 and a container payload 320. In one example, the container header 310 and the container payload 320 are incorporated into a single container 305 which may be incorporated into a single transport object 300 so that the container header 310 need not be recombined with information regarding where each container is located within different transported objects. Alternatively, the transport object 300 may contain a plurality of containers and a container may contain any number of ESG fragments 340. The container header 310 may contain information associated with a corresponding ESG fragment such as, for example, information regarding the container header 310 itself and/or the container payload 320.

In the example illustrated in FIG. 3, the ESG fragment 340 is contained in the container payload 320. The container header 310 may contain descriptors for identifying and describing ESG fragments in the corresponding container payload 320. Thus, the characteristics of the ESG fragment may be identified, such as but not limited to the position of the ESG fragment in the transport object 300 or the length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries, an ESG fragment 340 or a mixture thereof. In accordance with embodiments of the invention, the association of a 3GPP metadata envelope with an ESG fragment 340 may substitute for, or negate the need of additional metadata to be located in the header 310 in relation to that particular ESG fragment.

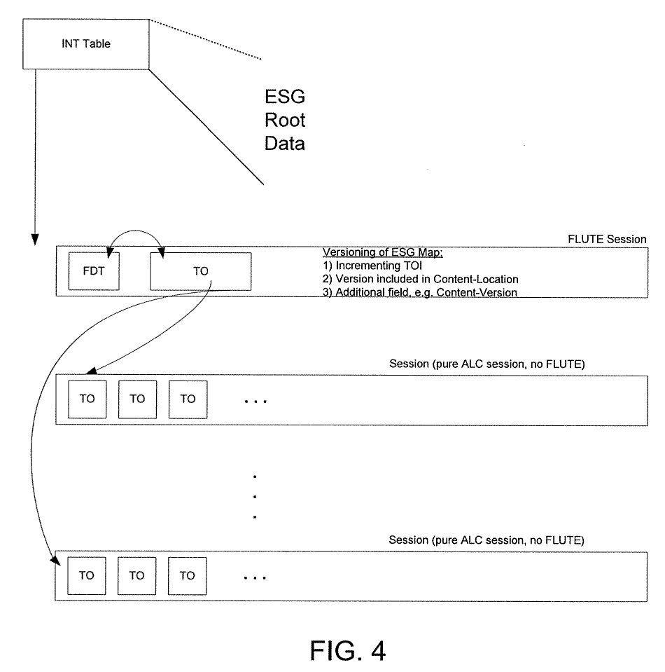

FIG. 4 illustrates an example of transmitting a plurality of single Transport Objects. As illustrated in FIG. 4, the Transport Objects (TO) of the current invention may be carried in, for example, FLUTE (File Delivery over Unidirectional Transport) sessions, or a pure Asynchronous Layered Coding (ALC) session. In the example of FIG. 4, the ESG Root Channel data, such as IP Address, port number and Transport Session Identifier (TSI), are announced in the IP/MAC Notification Table (INT Table) which may be, for example, carried in the SI/PSI stream in DVB-H as one of the SI tables of DVB-H. The FLUTE session of the ESG Root Channel comprises a File Delivery Table (FDT) of the session and one or more Transport Objects (TO). These Transport Objects that may be delivered in announcement carousels contain mapping between the different parts of ESGs and access parameters to the different ESG methods in which the ESG data is transmitted. The ESGs may differ from each other. For example, ESGs may be in different languages, genres or encoding.

Examples of access parameters may include, for example, IP addresses, port numbers, TSIs, start and end times etc. The FLUTE session thus declares how the ESG data is distributed to different sessions. The TOs of the FLUTE session carrying this mapping data are described in the FDT of the FLUTE session. The ESG mapping data may be delivered in one or multiple TOs. The mapping can be made using XML Schema, plain ASCII text, Structured ASCII text such as multipart MIME or MIME headers, as binary with enumerated types or through various other means as is known in the art. The ESG data is in this example may be delivered in one or more TOs, which may be within pure ALC sessions, for example. The ESG data or parts of it may be delivered in some embodiments of the invention in one or more FLUTE sessions in addition to or instead of ALC sessions.

Mobile broadcast services enable distribution of rich, interactive media content to a large mobile audience. Such services can be carried over a number of different broadcast networks such as DVB-T, DVB-H, Qualcomm FLO, T-DMB, S-DMB, WLAN, WiMAX, 3GPP/MBMS, 3GPP2/BCMCS, to name a few. In addition, the network may be combined with an interactive service such that 2G, 2.5G and 3G cellular systems, WLAN, etc.

In terminal provisioning, terminals within a mobile broadcast service may receive configuration parameters or objects over a broadcast channel. In one example, the configuration parameters received at a terminal may allow the programming of the terminal from a specific service provider or may permit updating of parameters within the terminal by the service provider. Also with terminal provisioning, mutual authentication may be accomplished such that the terminal receiving data is verified as a terminal authorized to be receiving the data. Likewise, the service provider may be verified as a proper service provider to be providing the data received at the terminal. The parameters or objects to be received at designated terminals may be distributed over a broadcast channel in terminal provisioning. Hence, the provision of various parameters or objects to terminals may be accomplished over a broadcast channel to manage terminal configuration, authentication of terminals or service providers, configuration of user credentials, connection setup, etc.

Further, the terminal provisioning function may be declared in an Electronic Service Guide (ESG) fragment. An ESG fragment may include multiple data fragments including, for example, a service fragment, a content fragment, or an access fragment. Any fragment of the ESG may be used to declare a terminal provisioning function including, for example, the service, access or content fragments of the service guide.

Different interfaces may be provided for the terminal provisioning function. In one example, an interface is provided for supporting the exchange of terminal provisioning and management messages in the network and the terminal. For example, in a bi-directional interaction network, both the network and the terminal support the exchange of terminal provisioning. Interface TP-7 is an example of an interface between OMA BCAST subscription management and the terminal for providing support for the exchange of terminal provisioning and management messages in the network and the terminal. Such interfaces may be, e.g., unidirectional or bi-directional.

In another example, an interface is provided that supports the delivery of provisioning messages at a terminal. For example, terminal provisioning and management messages may be provided over a broadcast distribution system to a terminal. The network may support delivery of provisioning messages. Alternatively, the network may not support delivery of provisioning messages. Interface TP-5 is an example of an interface between OMA BCAST Service Distribution/Adaptation and the terminal for providing terminal provisioning and management messages to a terminal, according to this example. Thus, in this example, terminal provisioning may be declared over a TP-5 interface and a type parameter, such as an AccessType parameter may contain a “BroadcastTransmission” element. The “BroadcastTransmission” element may further define the access to a BCAST file Distribution session. In another example, an interface is provided that supports the delivery or exchange of file objects as provisioning messages. In one example, the file objects are of the type “application/vnd.syncml.dm+wbxml.” Interface TP-4 is an example of an interface between OMA BCAST Service Distribution/Adaptation and OMA BCAST Subscription management for providing support for the delivery or exchange of file objects as provisioning messages. According to this example, exchange of data or data over interface TP-4 includes OMA DM provisioning messages. Also over this interface, the OMA DM provisioning messages may be exchanged as file objects of type “application/vnd.syncml.dm+wbxml”.

In one example, the existence or access of the terminal provisioning function may be provided in a service guide through a file distribution session carrying terminal provisioning messages over a corresponding interface, for example, a TP-5 interface. In this example, provisioning messages may be delivered as a file containing provisioning messages. One example of the type of file containing the provisioning messages may be of the type “application/vnd.syncml.dm+wbxml” which is a WAP Binary Extensible Markup Language (WBXML) encoded Open Mobile Alliance Device Management (OMA DM) message.

The WBXML encoded OMA DM message in this example may be declared in a service guide. For example, a service guide may contain a content fragment that may contain elements, sub-elements and/or attributes for specifying characteristics of a corresponding service including a file containing a provisioning message or parameter. For example, a content-type attribute or element of the file element in the service guide may specify terminal provisioning. In this example, a content fragment in a service guide is provided containing a file element or sub-element that may further contain a content-type parameter or attribute that may contain a file that contains an OMA DM provisioning message. In this example, the file containing the OMA DM provisioning message may have a value of “application/vnd.syncml.dm+wbxml,” for example.

In another example, a content fragment within a service guide may contain a parameter such as a FileDescription element, sub-element, or parameter that contains an OMA DM provisioning message. The file may be further contained within a sub-element or attribute of the File Description element or sub-element. As an example, the file may have a value of “application/vnd.syncml.dm+wbxml.” Also, as another example, the file may be contained with the “Content-Type” sub-element or attribute of the FileDescription element or sub-element.

In addition, the file containing the OMA DM provisioning messages may be compressed, if desired. In one example, the compression is performed on the file as a whole. In another example, the compression is performed only on a selected portion of the file. Compression may be declared and may be signaled by setting the value of a corresponding parameter to a value indicating that the file is compressed. As one example, the value of “Content-Encoding” may be set to “application/gzip” to demonstrate compression.

In another example, terminal provisioning may be declared as a service in a service fragment of a service guide. The service fragment may contain an attribute, such as a “type” attribute, which may identify a type of service associated with the service guide, including a type attribute that describes the type of service guide as a terminal provisioning service.

In another example, an access fragment is provided in the service guide for providing terminal provisioning. The access fragment may contain an access type sub-element that may further contain an element for defining the type of access. For example, if the interface declared for terminal provisioning is TP-5, then the access type may contain a “BroadcastTransmission” element. In another example, the interface declared for terminal provisioning is TP-7, an interface between OMA BCAST subscription management and the terminal. In this example, the access type may contain an “InteractiveTransmissionScheme” element. This may further define the access to the respective OMA DM server.

In addition, the service guide may further contain a content fragment that may include elements, sub-elements or attributes for specifying terminal provision messages as a file. The file may, for example, have a value of “application/vnd.syncml.dm+wbxml.”

In accordance with another aspect of the invention, terminal provisioning may be declared as an access of a service. According to such an example, the service fragment of a service guide defines a service of a particular type. The type defined may include any type including, for example, a basic TV, non-interactive or interactive type, a clipcast, a mixed basic TV and clipcast interactive or non-interactive, a basic radio interactive or non-interactive, a file download service, a software management service, etc. In addition, an access fragment of the service guide associated with the corresponding service may contain a parameter, such as an ApplicationSpec parameter, for defining the access specification that may be used by the application type to consume the service. The parameter (e.g., the ApplicationSpec parameter) may have a value of a file containing a provisioning message. As one example, the file may have a value of “application/vnd.syncml.dm+wbxml.” The access fragment may further contain a parameter describing a type of access. This parameter may be, for example, an AccessType parameter. Parameter describing the type of access may vary depending on the type of interface used in the communication network. For example, the type parameter may have a value of “BroadcastTransmission” describing the file distribution session (e.g. Flute session) if the interface is a TP-5 interface. Alternatively, the type parameter may have a value of “InteractiveTransmissionScheme” describing the access to a respective server if the interface is a TP-7 interface.

In addition, the service guide for providing terminal provisioning as an access of a service may further contain a content fragment for specifying terminal provisioning messages as a file. The file may, for example, have a value of “application/vnd.syncml.dm+wbxml.”

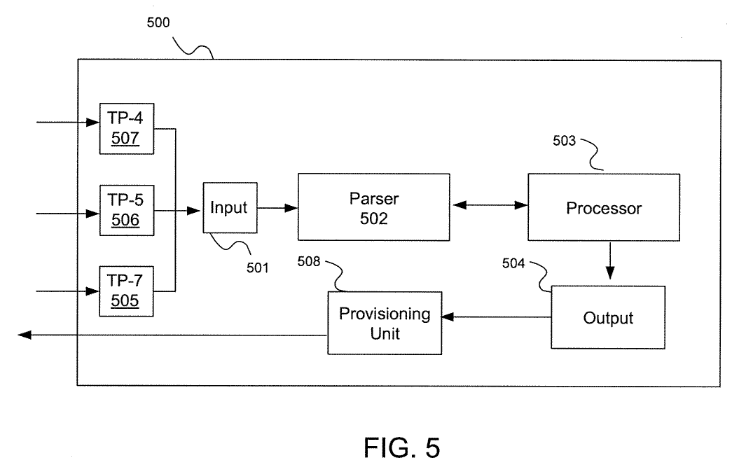

FIG. 5 is a partial block diagram illustrating an example of a receiver or terminal according to an aspect of the invention. In this example, the receiver 500 contains an input 501. The input 501 may be configured to receive information transmitted as an ESG fragment or transmitted using an ESG fragment transportation mechanism. The ESG fragment may also be received through an interface. As FIG. 5 illustrates, a TP-7 interface 505 may receive the ESG, for example, over a bi-directional interaction network. In this example, terminal provisioning messages may be exchanged between the network and the receiver 500. Alternatively, an ESG may be received via a TP-5 interface 506. In this example, terminal provisioning messages may be delivered to the receiver 500 through the network. The network may also receive data from the receiver 500. An ESG may be received via a TP-4 interface 507 in which the provisioning messages in the ESG may be provided as a file object. For example, the file object may be of the type “application/vnd.syncml.dm+wbxml.”

The receiver 500 may further include a parser 502 for identifying parameters in an ESG fragment associated with terminal provisioning. For example, the parser may identify a parameter associated with a file, the file containing an OMA DM provisioning message. In this example, the parser 502 may identify a content fragment in the service guide. The parser 502 may further identify an attribute within the content fragment for determining parameters associated with terminal provisioning. As one example, the attribute may be a content type attribute of an element providing a file description (e.g., FileDescription element). The element may also be, for example, an element for providing parameters associated with the file. In one example, the file has a value of application/vnd.syncml.dm+wbxml.

Alternatively, the parameters associated with the file may be signaled in-band. In this example, the attribute associated with the content type in the File Delivery Table (FDT) may be used. For example the parser 502 may identify an attribute associated with the content type in the FDT. In this example, the content type in the FDT may be used.

The receiver 500 may further include a processor 503 for controlling or instructing the parser 502 for identifying a corresponding parameter from within the ESG fragment to identify the terminal provisioning. Data corresponding to the terminal provisioning may be output by output 504. For example, the data may be displayed for the user or subscriber.

In one example, terminal provisioning is declared as a service in a service guide. A service guide containing terminal provisioning information is received at the receiver input 501 informing types TP-7 (505), TP-5 (506) or TP-4 (507). Further, the service guide may include a service fragment that may further contain an attribute for indicating terminal provisioning services. In one example, the service fragment of the service guide contains a “type” attribute that has a value corresponding to terminal provisioning services.

Also in this example, the service guide may also contain an access fragment that may include information pertaining to terminal provisioning. The access fragment may include, for example, a type attribute (e.g., AccessType) that may indicate the type of transmission and access to the network. In one example, the service guide is received via the TP-5 interface (506), and the type attribute in the access fragment (e.g., AccessType) indicates a broadcast transmission. In another example, the service guide is received via the TP-7 interface (505), and the type attribute in the access fragment (e.g., AccessType) indicates an interactive transmission scheme.

The service guide may further include a content fragment that may specify terminal provisioning. In this example, the service guide received at input 501 may include a file in a content fragment, the file specifying terminal provisioning messages. In one example, the file has a value of application/vnd.syncml.dm+wbxml.

The parser 502 of the receiver 500 may identify separate parameters or elements within the service guide. For example, when terminal provisioning is declared as a service, the parser 502 may identify a type attribute within a service fragment of a service guide received at the input 502. The type attribute may indicate terminal provisioning services. Also, the parser 502 may identify a type attribute within an access fragment of the service guide. The type attribute in the access fragment may vary based on the type of interaction with the network. For example, in the case of a service guide received in which terminal provisioning is declared via the TP-5 interface (506), the access type attribute may be a broadcast transmission. Alternatively, when terminal provisioning is declared via the TP-7 interface (505), the access type attribute may be an interactive transmission scheme.

The receiver may further include a provisioning unit 508. The provisioning unit 508 may process data in the terminal based on the terminal provisioning parameters or elements identified in the received service guide by the parser 502. In one example, the receiver 500 may permit updating of parameters within the receiver by the service provider based on the terminal provisioning parameters received in the service guide. For example, a service guide containing a type attribute in a service fragment indicating terminal provisioning services, an access type attribute in an access fragment indicating a broadcast transmission and a file specifying terminal provisioning messages in a content fragment may be received via interface TP-5 (506). The parser identifies the parameters, elements or files received and may use parameters within the receiver 500 based on the parameters received in the file specifying terminal provisioning messages in the content fragment. The receiver may further perform any relevant function based on the terminal provisioning file received in the content fragment or the terminal provisioning parameters or elements received in the service or access fragments. As another example, the receiver 500 may allow access to a service provider based on the terminal provisioning files and parameters received in the service guide. Also, the service provider may grant access to a program or service associated with the service guide based on the terminal provisioning parameters or files contained in the service guide. In one alternative embodiment, a service provider may give access to a program or service through provisioning parameters. Only part of the service or program in this example may be accessed which may be based on the capability of utilizing parameters enabling, e.g., broadcast and interactive services.

In another example, terminal provisioning is declared as an access of a service. In this example, a service guide may be received at the receiver 500 at an input 501 via an interface, such as a TP-4 interface (507), a TP-5 interface (506) or a TP-7 interface (505). The service fragment may contain terminal provisioning in which terminal provisioning is declared as an access of a service. In this example, the service guide may contain a service fragment that may further contain a type attribute. The service guide may further contain an access fragment. The access fragment may contain an element for specifying an application corresponding to the terminal provisioning of the service guide. In one example, the type element in the access fragment is an AccessType element. In another example, the type element has a value of application/vnd.syncml.dm+wbxml.

The service guide in this example may further contain a content fragment that may further contain a file specifying terminal provisioning. In one example, the file has a value of application/vnd.syncml.dm+wbxml.

The service guide declaring terminal provisioning as an access of a service may be received via interface TP-5, for example. The parser 502 may parse the service guide to identify the terminal provisioning parameters, elements or files. In this example, service guide contains an access fragment that further contains a type attribute that indicates that access type as broadcast transmission. In another example, the service guide is received via the TP-7 interface, and the access type attribute indicates the access type as interactive transmission scheme.

The parameters, elements and files corresponding or specifying terminal provisioning are received and processed. The service guide and associated parameters, elements or files are output via output 504. Also, the provisioning unit may perform further processing based on the received parameters, elements, or files associated with terminal provisioning received in the service guide. For example, the receiver 500 may be authenticated for a particular service provider based on the terminal provisioning parameters and files received in the service guide.

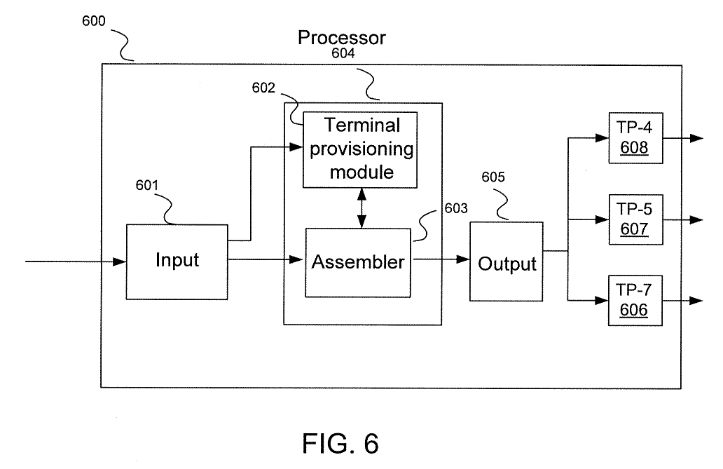

FIG. 6 is a partial block diagram illustrating an example of a transmitter according to one aspect of the invention. In this example, the transmitter 600 includes an input 601 for receiving data to be included in an ESG fragment for transmission. This data may be received from a variety of sources, for example, a service provider or broadcaster. The transmitter 600 may further include a processor 604 for assembling or processing an ESG fragment corresponding to a program or service.

FIG. 6 illustrates the processor 604 as containing a terminal provisioning module 602 and an assembler 603. However, any of these components may be separate from the processor 604, if desired.

The terminal provisioning module 602 may determine terminal provisioning associated with the ESG fragment. For example, a service provider may wish to transmit service guide information to specified terminals or receivers such as terminals or receivers that are authorized to receive the service guide. Thus terminal provisioning information regarding authorized receivers may be transmitted to the transmitter 600 and may be processed within the terminal provisioning module 602 to be included in a service guide.

The transmitter 600 may further include an interface for interfacing with a broadcast distribution system or network. For example, the transmitter may include a TP-4 interface (608), a TP-5 interface (607) or a TP-7 interface (606). As one example, a service guide is transmitted to a receiver or group of receivers from the transmitter 600 in which user interaction at the receiver or group of receivers is not provided. In this example, the transmitter may transmit the service guide via the TP-5 interface (607). In another example, the service guide is transmitted to a receiver in which user interaction is provided. In this example, the service guide may be transmitted via the TP-7 interface (606).

In one example, the transmitter 600 processes the service guide to include terminal provisioning declared as a service. In this example, the assembler 603 assembles a service guide for transmission over a network to a receiver or group of receivers. In this example, authentication information is specified in terminal provisioning parameters, elements or files included in the service guide. The assembler 603 may include a service fragment in the service guide, the service fragment further including a type attribute. In this example, the type attribute may have a value indicating terminal provisioning services. The assembler 603 may further include an access fragment in the service guide, the access fragment further including a type element for defining access to the service guide. For example, in a network system in which a service guide and a corresponding program or service may be transmitted to a receiver such that interaction or input from the receiver is not indicated, the access type attribute of the access fragment may indicate a broadcast transmission, and the service guide may be transmitted via the TP-5 interface (607). Alternatively, in a system in which interaction or input from the receiver is indicated, the access type attribute of the access fragment may indicate an interactive transmission scheme, and the service guide may be transmitted via the TP-7 interface (606).

Also in this example, the assembler 603 may include a content fragment in the service guide, the content fragment including a file for specifying the terminal provisioning messages. In one example, the file has a value of application/vnd.syncml.dm+wbxml. The service guide may be output from the transmitter 600 via an output 605 and may be transmitted to a remote terminal.

In another example, the transmitter 600 assembles a service guide in which terminal provisioning is declared as an access of a service. In this example, terminal provisioning information may be received in the terminal provisioning module 602. One example includes authentication information received from a service provider for providing the service guide to authenticated users only. The assembler 603 may assemble a corresponding service guide including a service fragment, an access fragment, and a content fragment, for example. The service fragment may contain a type attribute, which may indicate terminal provisioning or any type of service. The access fragment may further include an element indicating an application associated with terminal provisioning. For example, the access fragment may include an ApplicationSpec element. The element may further have a value of applicationi/vnd.syncml.dm+wbxml.

In addition, the access fragment may include a type attribute for defining the access to the service guide. For example, the type may be specified as a broadcast transmission or as an interactive transmission scheme, accordingly.

The content fragment in this example may include a file specifying the terminal provisioning. As one example, the file may have a value of application/vnd.syncml.dm+wbxml.

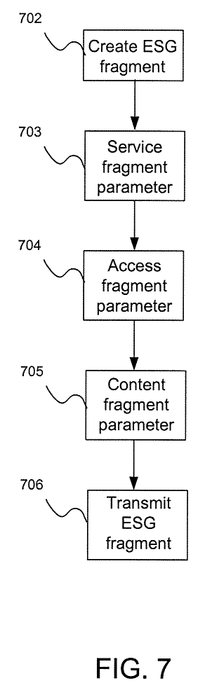

FIG. 7 is a flowchart illustrating an example of transmitting a service guide associated with terminal provisioning. In this example, a service guide or ESG fragment is created in STEP 702. For example, a transmitter may create an ESG fragment containing information pertaining to a corresponding program or service which may include terminal provisioning parameters or messages to a receiver or group of receivers. The ESG fragment may include, for example, a service fragment that may further include a type attribute corresponding to terminal provisioning services (STEP 703). In another example, the parameter or attribute may be an integer value of a type parameter within the service fragment, the integer value corresponding to an indication of terminal provisioning.

The ESG fragment may further include an access fragment for indicating how a terminal may access a service and may further include a type element for defining access to the service guide or ESG fragment (STEP 704). As one example, the access type may be indicated as broadcast transmission (e.g., transmitted via a TP-5 interface). Alternatively, the access type may be indicated as an interactive transmission scheme (e.g., transmitted via a TP-7 interface). In addition, the access fragment may include an element for indicating the application associated with terminal provisioning such as an ApplicationSpec element with a value of application/vnd.syncml.dm+wbxml (STEP 704).

The ESG fragment may further include a content fragment which may include a file for specifying terminal provisioning message (STEP 705). In one example, the file may be of the type application/vnd.syncml.dm+wbxml, which is a WBXML encoded OMA DM message.

In STEP 706, the ESG fragment is transmitted to a terminal or receiver. The terminal or receiver may thus receive terminal provisioning data such as, for example, terminal configuration parameters, data, or applications.

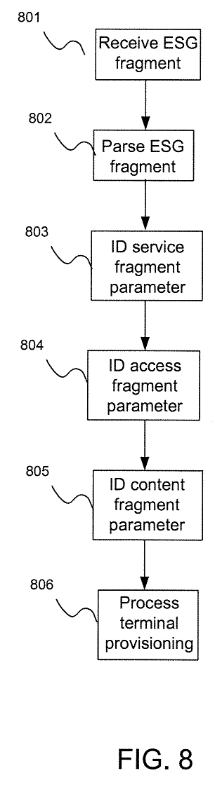

FIG. 8 is a flowchart illustrating an example of a receiver or terminal receiving terminal provisioning data in an ESG fragment. In STEP 801 of this example, the terminal or receiver receives an ESG fragment. In STEP 802, a parser at the terminal may parse the ESG fragment for data associated with terminal provisioning. The ESG fragment may contain a service fragment which may contain a parameter, such as a type attribute indicating a type of terminal provisioning services, associated with terminal provisioning which may be identified at the terminal (STEP 803).

The ESG fragment may further include an access fragment containing a type parameter. In addition, the ESG fragment may contain an element specifying an application associated with terminal provisioning. In one example, the element is an applicationSpec element with a value of application/vnd.syncml.dm+wbxml (STEP 804).

The ESG fragment may further include a content fragment (STEP 805), including a file specifying terminal provisioning messages. In one example, the files may contain an OMA DM provisioning message. The file may further be of the type application/vnd.syncml.dm+wbxml, which is a WBXML encoded OMA DM message. In STEP 806, terminal provisioning parameters are received and processed at the terminal.

Embodiments of the invention include any novel feature or combination of features disclosed herein either explicitly or any generalization thereof. While embodiments of the invention have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

1. A method comprising:
providing parameters corresponding to a file containing a data management provisioning message, the file being a data management message;
declaring a type corresponding to the file; and
distributing the file to the terminal.

2. The method of claim 1 wherein the parameters corresponding to the file are distributed in a service guide.

3. The method of claim 2 wherein the service guide includes a content fragment.

4. The method of claim 3 wherein the declaring step comprises providing an attribute in the content fragment, the attribute determining the type of the file.

5. The method of claim 4 wherein the attribute in the content fragment has a value of application/vnd.syncml.dm+wbxml.

6. The method of claim 5 wherein the attribute is within an element of the content fragment, the element providing a description of the file.

7. The method of claim 5 wherein the attribute is within an element of the content fragment, the element providing parameters corresponding to a file.

8. A method comprising:
providing a service fragment having a type of terminal provisioning services;
providing an access fragment for specifying access to the service; and
distributing an ESG fragment to the terminal, the ESG fragment containing the service fragment and the access fragment.

9. The method of claim 8 wherein the service fragment comprises an attribute for determining the type of the corresponding service.

10. The method of claim 9 wherein the attribute comprises a parameter for specifying terminal provisioning services.

11. The method of claim 10 wherein the parameter has a value corresponding to terminal provisioning services.

12. The method of claim 8 wherein the access fragment comprises an attribute for defining the type of session corresponding to the service.

13. The method of claim 12 wherein the attribute defines the type of session as a broadcast transmission.

14. The method of claim 13 wherein the distributing includes transmitting the file to the terminal over a terminal provisioning interface.

15. The method of claim 8 wherein the access fragment comprises an attribute for defining the type of session corresponding to the service and wherein the attribute defines the type of session as an interactive transmission scheme.

16. The method of claim 15 wherein the terminal provisioning is provided over a terminal provisioning interface.

17. The method of claim 8 further comprising providing a content fragment, the content fragment specifying the terminal provisioning message as a file, wherein the ESG fragment further comprises the content fragment.

18. The method of claim 17 wherein the file has a type of application/vnd.syncml.dm+wbxml.

19. The method of claim 18 wherein the content fragment contains an attribute within an element, the element providing a description of the file.

20. The method of claim 18 wherein the content fragment contains an attribute within an element of the content fragment, the element providing parameters of the file.

21. A method comprising:
providing a service fragment corresponding to a service;
providing an access fragment for specifying access to the service, wherein the access fragment comprises an element having a value corresponding to an encoded device management message; and
distributing an ESG fragment to the terminal, the ESG fragment containing the service fragment and the access fragment.

22. The method of claim 21 wherein the access fragment comprises an attribute for defining the type of session corresponding to the service.

23. The method of claim 22 wherein the attribute defines the type of session as a broadcast transmission.

24. The method of claim 23 wherein the terminal provisioning is provided over a terminal provisioning interface.

25. The method of claim 21 wherein the access fragment comprises an attribute for defining the type of session corresponding to the service and wherein the attribute defines the type of session as an interactive transmission scheme.

26. The method of claim 25 wherein the terminal provisioning is provided over a terminal provisioning interface.

27. The method of claim 21 further comprising providing a content fragment, the content fragment specifying the terminal provisioning message as a file, wherein the ESG fragment further comprises the content fragment.

28. The method of claim 27 wherein the file has a type of application/vnd.syncml.dm+wbxml.

29. The method of claim 28 wherein the content fragment contains an attribute within an element, the element providing a description of the file.

30. The method of claim 28 wherein the content fragment contains an attribute within an element of the content fragment, the element providing parameters of the file.

31. An apparatus comprising:
an input configured to receive data to be included in an ESG fragment for transmission;
a terminal provisioning module configured to determine terminal provisioning data associated with the ESG fragment including an attribute defining a type of service; and
an ESG fragment assembler configured to assemble the ESG fragment with a service fragment and an access fragment, the service fragment including the attribute, wherein the attribute has a value corresponding to terminal provisioning services.

32. The apparatus of claim 31 wherein the access fragment comprises an element having a value defining a type of access as broadcast transmission.

33. The apparatus of claim 32 further comprising a terminal provisioning interface configured to provide terminal provisioning.

34. The apparatus of claim 31 wherein the access fragment comprises an element having a value defining a type of access as interactive transmission scheme.

35. The apparatus of claim 34 further comprising a terminal provisioning interface configured to provide terminal provisioning.

36. An apparatus comprising:
an input configured to receive data to be included in an ESG fragment for transmission;
a terminal provisioning module configured to determine terminal provisioning data associated with the ESG fragment including an element defining an application type consuming a service corresponding to the ESG fragment; and
an ESG fragment assembler configured to assemble the ESG fragment with a service fragment and an access fragment, the access fragment including an element, wherein the element has a value corresponding to encoded device management message.

37. The apparatus of claim 36 wherein the access fragment comprises an element having a value defining a type of access as broadcast transmission.

38. The apparatus of claim 37 further comprising a terminal provisioning interface configured to provide terminal provisioning.

39. The apparatus of claim 36 wherein the access fragment comprises an element having a value defining a type of access as interactive transmission scheme.

40. The apparatus of claim 39 further comprising a terminal provisioning interface configured to provide terminal provisioning.

41. The apparatus of claim 39 wherein the ESG fragment assembler further assembles the ESG fragment with a content fragment, the content fragment including a terminal provisioning message as a file.

42. The apparatus of claim 41 wherein the file has a type of application/vnd.syncml.dm+wbxml.

43. An apparatus comprising:
an input configured to receive the ESG fragment;
a parser configured to identify a first parameter and a second parameter, the first parameter being within a service fragment of the ESG fragment and the second parameter being within an access fragment of the ESG fragment, wherein at least one of the first parameter and the second parameter indicates terminal provisioning associated with a service; and
a processor configured to process the terminal provisioning as one of a service and an access of a service.

44. The apparatus of claim 43 wherein the first parameter is a type attribute with a value corresponding to a terminal provisioning service.

45. The apparatus of claim 44 further comprising a terminal provisioning interface, wherein the second parameter is a type parameter for describing the access type and wherein the terminal provisioning interface is configured to receive the terminal provisioning service.

46. The apparatus of claim 45 wherein the second parameter has a value corresponding to a broadcast transmission.

47. The apparatus of claim 43 further comprising a terminal provisioning interface, wherein the first parameter is a type attribute with a value corresponding to a terminal provisioning service and wherein the second parameter is a type parameter for describing an access type.

48. The apparatus of claim 47 wherein the second parameter has a value corresponding to an interactive transmission scheme.

49. The apparatus of claim 43 wherein the second parameter is an element for defining the application type consuming the service.

50. The apparatus of claim 49 wherein the second parameter has a value corresponding to application/vnd.syncml.dm+wbxml.

51. A computer readable medium containing computer executable instructions for causing an apparatus to perform the steps comprising:
receiving an electronic service guide (ESG) fragment associated with a service, the ESG fragment having a first parameter within a service fragment of the ESG fragment and a second parameter within an access fragment of the ESG fragment, wherein at least one of the first parameter and the second parameter indicates terminal provisioning associated with a service; and
receiving the terminal provisioning associated with the service.

52. A system comprising:
a transmitter configured to provide terminal provisioning in an electronic service guide (ESG) fragment
an input configured to receive data to be included in an ESG fragment for transmission,
a terminal provisioning module configured to determine terminal provisioning data associated with the ESG fragment including an attribute defining a type of service, and
an ESG fragment assembler configured to assemble the ESG fragment with a service fragment and an access fragment, the service fragment including a first parameter and the access fragment including a second parameter, wherein at least one of the first parameter and the second parameter indicates terminal provisioning associated with a service; and
a receiver configured to receive terminal provisioning in an ESG fragment a receiver input configured to receive the ESG fragment,
a parser configured to identify the first parameter and the second parameter, and
a processor configured to process the terminal provisioning as one of a service and an access of a service.

53. The system of claim 52 wherein the access fragment comprises an element having a value defining a type of access as broadcast transmission.

54. The system of claim 53 further comprising a terminal provisioning interface configured to provide terminal provisioning.

55. The system of claim 52 wherein the access fragment comprises an element having a value defining a type of access as interactive transmission scheme.

56. The system of claim 55 further comprising a terminal provisioning interface configured to provide terminal provisioning.

57. The system of claim 52 wherein the access fragment comprises an element having a value corresponding to application/vnd.syncml.dm+wbxml.

58. An apparatus comprising:
means for providing parameters corresponding to a file containing a data management provisioning message, the file being an encoded data management message;
means for declaring a type corresponding to the file; and
means for distributing the file to the terminal.

59. The apparatus of claim 58 wherein the parameters corresponding to the file are distributed in a service guide.

60. The apparatus of claim 59 wherein the service guide includes a content fragment.

61. The apparatus of claim 60 wherein the means for declaring comprises means for providing an attribute in the content fragment, the attribute determining the type of the file.

62. The apparatus of claim 61 wherein the attribute in the content fragment has a value of application/vnd.syncml.dm+wbxml.

63. The apparatus of claim 62 wherein the attribute is within an element of the content fragment, the element providing a description of the file.

64. The apparatus of claim 62 wherein the attribute is within an element of the content fragment, the element providing parameters corresponding to a file.
